(19) United States
(12) Patent Application Publication
(10) Pub. No.: US 2017/0018943 A1
(43) Pub. Date: Jan. 19, 2017

(54) POWER GENERATION DEVICE UTILIZING RENEWABLE NATURAL ENERGY

(71) Applicant: YUTAKA NEMOTO, FUKUOKA (JP)

(72) Inventor: YUTAKA NEMOTO, FUKUOKA (JP)

(21) Appl. No.: 15/278,390

(22) Filed: Sep. 28, 2016

Related U.S. Application Data
(63) Continuation of application No. PCT/JP2015/061800, filed on Apr. 17, 2015.

(30) Foreign Application Priority Data
Apr. 18, 2014 (JP) 2014-086812

(51) Int. Cl. H02J 7/00; H02K 47/20; H02K 3/04; F03D 9/11; H02J 7/35; H02K 7/10; F03D 17/00

(52) U.S. Cl. CPC H02J 7/0068; H02K 7/1004; H02K 47/20; F03D 17/00; F03D 9/11; H02J 7/35; H02K 3/04

(57) ABSTRACT

A power generation device using renewable energy includes: a storage battery configured to temporarily store electric power generated through renewable energy; and a plurality of electric power generators along with a motor, the plurality of electric power generators configured to be caused, by the motor driven through electric power output from the storage battery, to rotate so as to further generate electric power, of which one portion is charged into the storage buttery and the other portion is output to an interconnection system as consumed electric power.

### CROSS REFERENCE TO RELATED APPLICATIONS

This is a continuation application of International Patent Application No. PCT/JP2015/061800 filed on Apr. 17, 2015 claiming priority upon Japanese Patent Application No. 2014-086812 filed on Apr. 18, 2014, of which full contents are incorporated herein by reference.

### BACKGROUND OF THE INVENTION

Field of the Invention

The present invention relates to an electric power generation device configured such that: unstable electric power generated from various types of renewable natural energy whose fuel cost is zero is stored in a storage battery dedicated to an electric power generation device; a motor dedicated to the electric power generation device is driven by the electric power stored in the storage battery; and the rotational motion of the motor is used to cause a generator to rotate installed and dedicated to generate electric power to be actually used as consumed electric power, thereby obtaining consumed electric power whose fuel cost is zero.

All electric power generated from a generator installed in parallel on the same shaft other than the generator for generating consumed electric power is stored in said storage battery as consumed electric power for the motor dedicated to the electric power generation device.

Description of the Background Art

Electric power has been required more than anything else in environments in which modern people has been alive. Among various types of electric power, attention has been drawn to electric power generated through renewable natural energy assumed to be environmentally friendly, as energy compatible with the laws of nature, more than energy generated through fossil fuel having destroyed the natural environment. Disadvantageously, however, since such energy deals with natural power, it has been unstable and only a small amount of generated electric power could be obtained. As a result, it has been difficult to connect such electric power directly to a power system.

### PRIOR ART DOCUMENTS

### Patent Documents

Patent Document 1: Japanese Unexamined Patent Application Publication No. 2003-83232

### Problems to be Solved

In this respect, as disclosed in Patent Document 1, an invention in which the cut-in wind speed has been lowered to increase the movable range is known. However, the movable range has been only slightly extended, and the effect of enhancement has been insignificant.

### SUMMARY OF THE INVENTION

In view of the above problems, the technical objective of the present invention is to focus on the above problems while considering how to efficiently utilize the electric power generated by the renewable natural energy, even if it is unstable and small in amount as described above, as long as it does not adversely affect the natural environment. Hence, the aim is to compensate for the weakness of the renewable natural energy and to enable generation of high-output, high-efficiency, stable consumed electric power.

### Means for Solving Problems

As a first aspect of the present invention, there is disclosed an electric power generation device configured such that electric power generated through renewable natural energy whose fuel cost is zero is temporarily stored in a storage battery, and electric power output from the storage battery is used to drive a motor dedicated to said electric power generation device, and simultaneously cause a plurality of generators to rotate through the rotational motion of the motor. The device therefore enables usage of the electric power, either self-consuming it as electric power for private power generation or interconnecting all the electric power generated to a system at a price according to the feed-in tariff. Simultaneously, said device is also an electric power generation device having a generator dedicated to charging configured to work so as to store a portion of the electric power in the storage battery dedicated to said electric power generation device. “Renewable natural energy” refers to wind power, sunlight, hydroelectric power, tidal power, wave power, ocean current energy, geothermal energy, and bioenergy, and two or more kinds of electric power generated individually by two or more of the same or different types of energy are also included. In other words, two or more kinds of electric power may be stored in one storage battery.

As a second aspect of the present invention, there is disclosed an electric power generation device using renewable energy according to the first aspect of the present invention, whose circuit is configured such that commercial electric power can be used in combination to drive the motor when necessary.

As a third aspect of the present invention, there is disclosed an electric power generation device using renewable energy according to the first or second aspect of the present invention, where various types of renewable energy [in addition to wind power or sunlight, water pressure of a water supply, water pressure of agricultural water, or water pressure of pumped-storage power generation] are used as electric power sources.

As a fourth aspect of the present invention, there is disclosed an electric power generation device using renewable energy according to the first, second, or third aspect of the present invention, where, as the feature of the plurality of generators adopted in the electric power generation device, the coil is formed in a concave shape and is caulked in a state where the coil is wound circularly without creating gaps as much as possible, both side surfaces of a permanent magnet arranged in a concave shaped groove with as little gap as possible are caused to rotate so as to be opposite to each other to reduce the cogging torque as much as possible, and thus enable highly efficiently power generation even at a low wind speed.

As a fifth aspect of the present invention, there is disclosed an electric power generation device using renewable energy according to the first, second, third, or fourth aspect of the present invention, where a rotational force of a shaft of a motor is used to drive a driven pulley of a generator for charging and a driven pulley of a generator for consumed electric power in order to outer rotors of a plurality of generators to generate electric power.

As a sixth aspect of the present invention, there is disclosed a method of generating electric power where the electric power generated from wind power, solar energy, or water pressure is temporarily stored in a storage battery, the electric power stored in the storage battery is used to drive a motor, a generator dedicated to the generation of consumed electric power and a generator dedicated to charging for generating electric power used as the power source of the motor are simultaneously cased to rotate, therefore, making it possible to individually generate necessary consumed electric power from the power whose fuel cost is zero.

### Advantageous Effects of the Invention

According to the fact that, as the first aspect of the present invention, the electric power is generated by various types of renewable energy and is temporarily stored in the storage battery, the electric power output from the storage battery is used to drive the motor, a plurality of generators are caused to rotate to generate the electric power, and a portion thereof is stored in the storage battery and the remaining portion thereof is output, as consumed electric power, to the interconnection of the system. Therefore, in spite of the fact that the renewable energy is used as input energy to generate electric power, the electric power output from the generator driven by the motor is output to the interconnection of the system and is consumed. Hence, despite the use of unstable renewable energy, it is possible to obtain a stable output.

According to the fact that, as the second aspect of the present invention, the circuit configuration is used in which commercial electric power can be used together to drive the motor, when there is not enough electric power in the storage battery to drive the motor, commercial electric power can be used as auxiliary power, making assurance double sure.

According to the fact that, as the third aspect of the present invention, water pressure of a water supply, water pressure of agricultural water, or water pressure of pumped-storage power generation is used as the renewable energy in addition to wind power or sunlight, the range of the renewable energy capable of being utilized is expanded, and can lead to an increase in the number of small-scale in-house electric power generation, possibly resulting in saving fossil energy which is limited in quantity.

According to the fact that, as the fourth aspect of the present invention, the coils of the plurality of generators are spaced in a state where the coils are wound circularly and formed in a concave shape such that they face both side surfaces of the permanent magnet, the spacing of the coils can be substantially decreased to reduce the size of the generator, and the cogging is also reduced. Moreover, by reducing the rotational speed, rotation at a low wind speed can be performed, resulting in a generator capable of obtaining an even highly efficient output.

According to the fact that, as the fifth aspect of the present invention, the rotational force of the shaft of the motor is used to drive the driven pulley of the generator for charging and the driven pulley of the generator for consumed electric power, it is possible to cause the outer rotors of a plurality of generators to generate electric power with a single motor driven by the output of the storage battery.

According to the fact, as the sixth aspect of the present invention, the electric power generated from wind power, solar energy, or water pressure is temporarily stored in the storage battery, the electric power output from the storage battery is used to drive the motor in order to rotate a plurality of generators to generate the electric power, and a portion of the output of the power is stored in the storage battery and the remaining portion of thereof is output, as consumed electric power, to the interconnection of the system, even if the electric power stored in the storage battery is unstable, electric power is output from the generator caused to rotate by the motor, hence resulting in stable high-output power.

### BRIEF DESCRIPTION OF THE DRAWINGS

For more thorough understanding of the present invention and advantages thereof, the following descriptions should be read in conjunction with the accompanying drawings in which:

FIG. 1 depicts a circuit diagram of a variable-speed magnetic power generation device according to the present invention;

FIG. 2 depicts a side view of a group of generators shown in FIG. 1;

FIG. 3 depicts a top view of the group of generators shown in FIG. 1;

FIG. 4 depicts a front view showing the relationship between the group of generators and pulleys shown in FIG. 1;

FIG. 5 depicts a cross-sectional view of a low-speed permanent winding induction coreless generator according to the present invention;

FIG. 6 depicts a perspective view of a coil which is shaped to envelope a magnet and the arrangement thereof;

FIG. 7 depicts a plan view showing a state of the connection of wires of the coil in FIG. 6;

FIG. 8 depicts a cross-sectional view taken along line A-A′ showing the front and back of the coil in FIG. 7; and

FIG. 9 depicts a side view showing the arrangement of the front and back of the coil on the side of a stator.

### DESCRIPTION OF EMBODIMENTS OF THE INVENTION

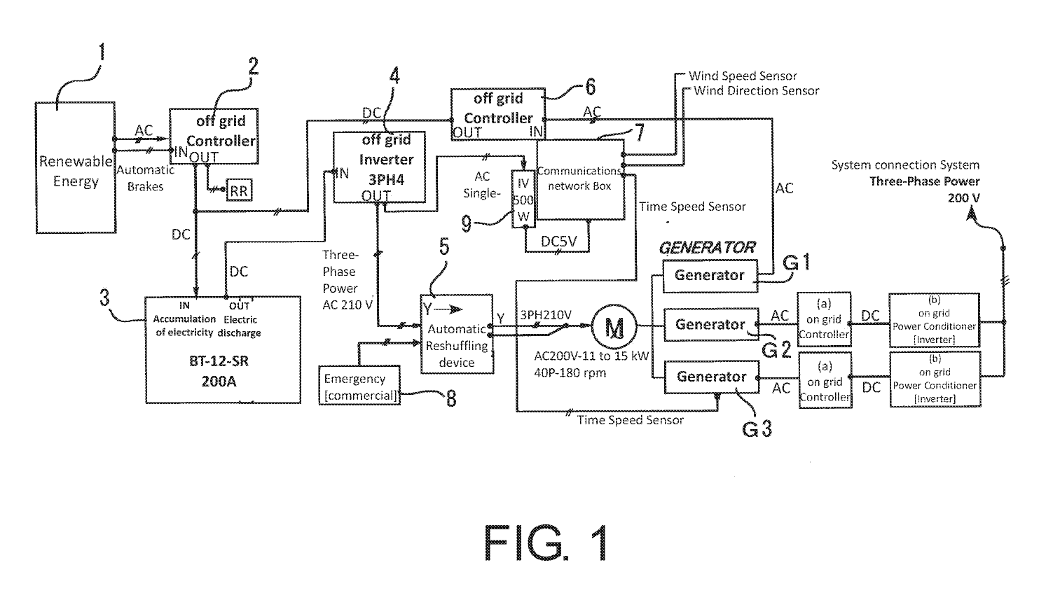

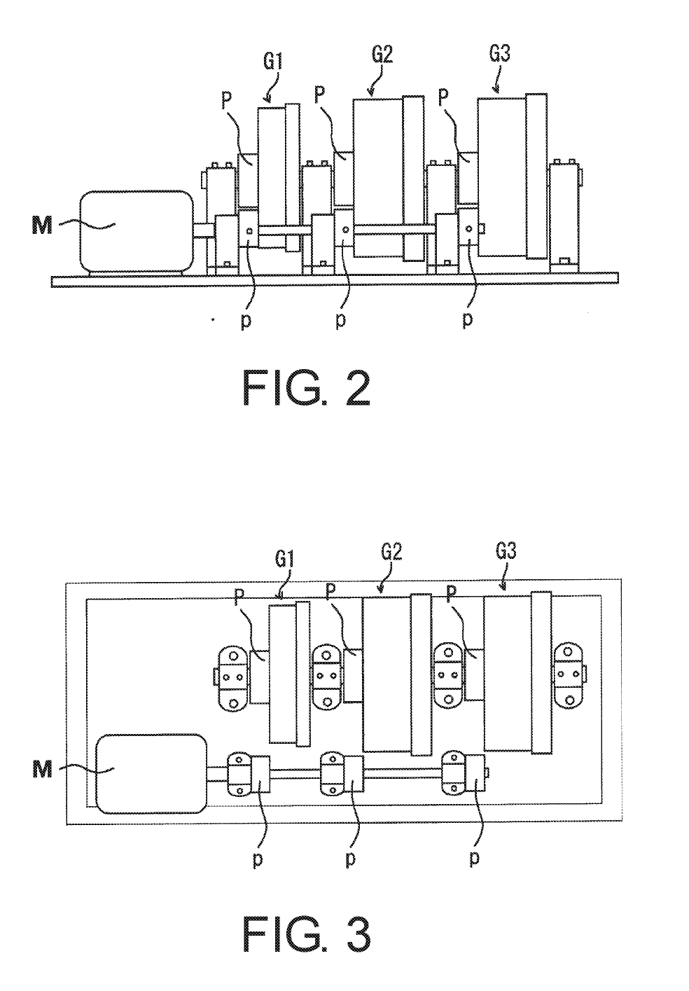

Hereinafter, descriptions on how a variable-speed magnetic power generation device according to the present invention is practically embodied will be provided, using embodiments. FIG. 1 depicts a block diagram showing the overall configuration of the variable-speed magnetic power generation device as an embodiment according to the present invention. Reference numeral 3 denotes a storage battery, and electric power (alternating-current) generated by a generator 1 using renewable natural energy is stored through a storage battery control system (Off Grid Controller) 2, and electric power (alternating-current) generated by a generator G1 incorporated into the device as an embodiment according to the present invention and is dedicated to charging is also stored in the storage battery 3 through an Off Grid Controller 6.

When an output of the storage battery 3 is fed through an automatic switching unit 5 to a motor M in a state where direct-current power is converted into alternating-current power by a storage battery conversion system (Off Grid Inverter) 4, the generators G1, G2, and G3 are caused to rotate so as to generate electric power. A communication device 7, to which the power obtained by converting the alternating-current power from the Off Grid Inverter 4 into a direct-current power through a converter 9 is supplied, receives information from the revolution indicator of the generator G3 at all times.

An output of the generator G1 is converted into direct-current power as described above and is then stored in the storage battery 3. On the other hand, with respect to the remaining two generators G2 and G3, alternating-current power is converted into direct-current power by a power generation control system (Off Grid Controller) (a), is then converted into a specified alternating-current voltage by a power generation conversion system (On Grind Inverter) Power Conditioner (b), and is thereafter interconnected to the system or is output as normal Grid consumed electric power.

In addition, electric power generated by a plurality of the same types or different types of renewable natural energy sources can be stored in the storage battery 3. Also, supposing a case where the output power from the storage battery 3 necessary for driving the motor M is insufficient, the output power of the storage battery 3 and commercial alternating-current 8 power can be used in combination as an emergency measure. Naturally, in that case, the power switching unit 5 highly prioritizing the output electric power of the storage battery is incorporated into the system so as to achieve the configuration described above.

In spite of the fact that the magnitude of the electric power generated and output by the renewable natural energy is not limited in particular, surplus power stored in the storage battery 3 may be interconnected to the system or may be output as the normal Grid consumed electric power. It is needless to say that, among the output power of solar panels and the outputs of a wind power generator and the like, only the power capable of being stored may be stored.

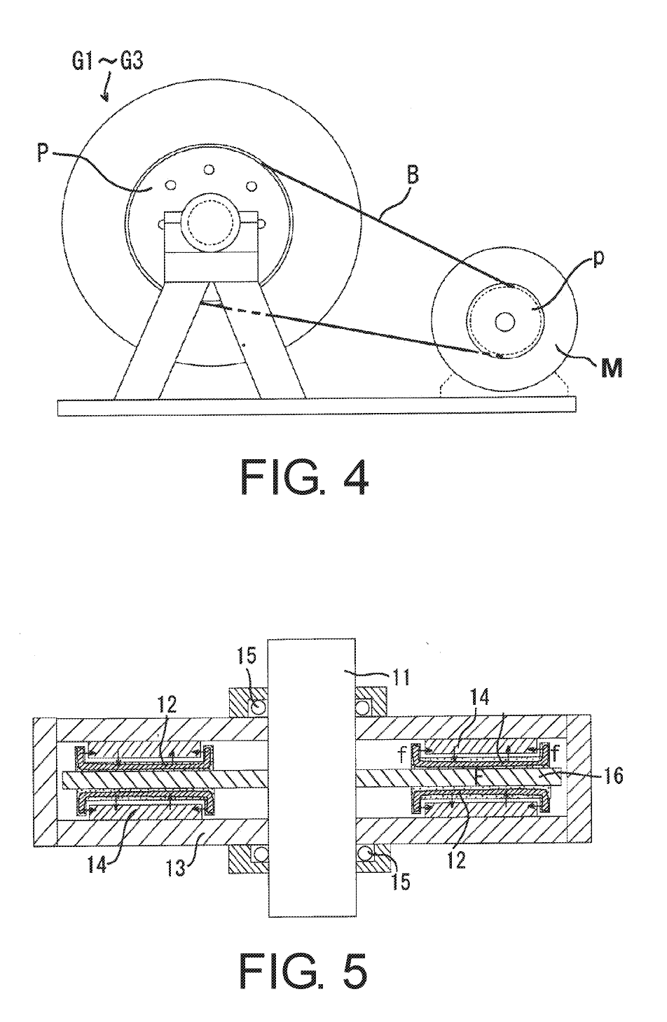

In the side view shown in FIG. 4, a belt B is placed over the driven pulleys P of the two generators G2 and G3 for consumed electric power and the one generator G1 for charging and the driving pulley p of the motor M. FIG. 5 is a cross-sectional view showing the internal structures of low-speed outer rotor permanent winding induction coreless generators G1, G2, and G3, and a shaft 11 in the portion of the stator of the generator is fixed so as to prevent it from rotating during use. In the center of the shaft 11 of the stator, there is a stator plate 16 where a magnetic steel plate 16 is partially used. There is also a coil 12 fixed to the inner surface of a rotor 13, which is attached to the upper and lower portions of the magnetic steel plate 16, and which is fixed by caulking as a one-piece stator. The coil 12 is formed in a concave shape matching the shape of a magnet 1 which the coil envelopes.

Within the generator of the rotor 13 used through the means of combining two upper and lower structures into one, bearings 15 are attached to each of the upper and lower structures, and are formed together with the stator shaft 11 to govern the rotation of the generator.

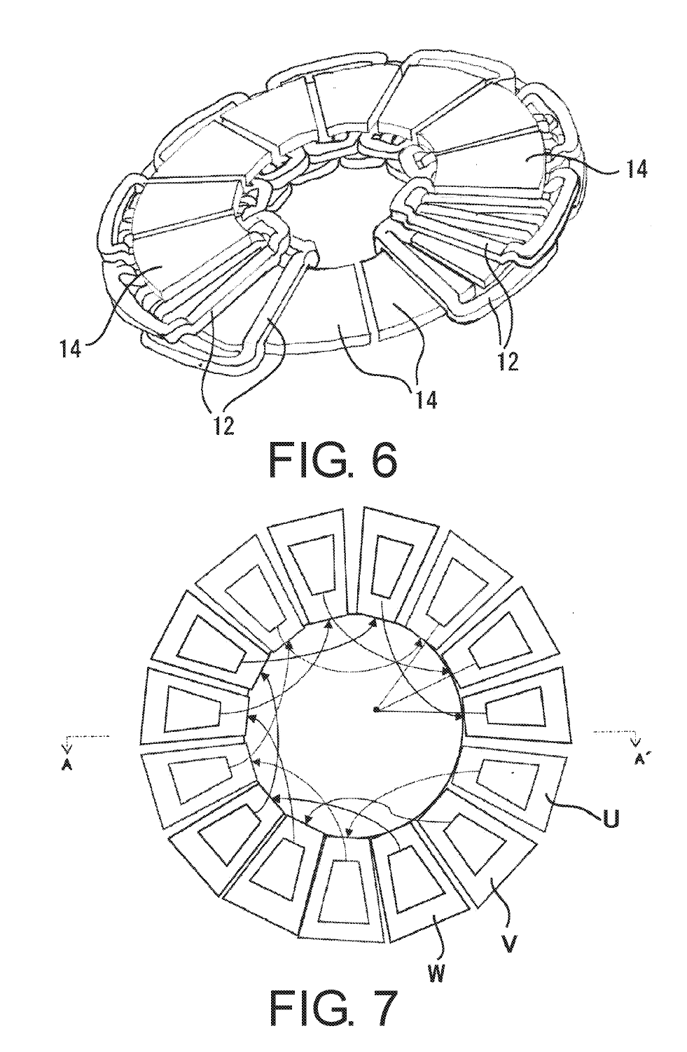

The shape obtained by forming the coil 12 in a concave shape so as to envelope the magnet according to its shape is as shown in FIG. 6 (the magnetic steel plate 16 in the middle is not shown), and characterizes the new coreless generator as an embodiment according to the present invention. In a conventional coreless generator, the attraction of the magnetic fields of the magnet and the coil happens in only one direction F, so at the time of lower-speed rotation, a cogging torque is produced. On the other hand, since the new coil 12 is formed in a concave shape so as to envelope the magnet 14 according to its shape as shown in FIGS. 5 and 6, the surface opposing the magnet 14 is enlarged and the magnet 14 moves, in a direction of f, within the magnetic field of the coil 12 resembling a linear motor. Thus, the proposed form of the coil is advantageous in that the production of the torque becomes flexible when the rotation has started.

The wire connections of the coils 12 are as shown in FIG. 7, and in the wire connections of the electrodes (the coils 12) of the low-speed permanent winding induction coreless generator, one pole (coil) is obtained by winding and overlaying an enameled wire obtained by insulating a copper wire of φ0.75 mm with polyester in an oval shape for 58 times. 15 poles (coils) are prepared and arranged in a circular shape to form one electromagnetic network.

In the case of the low-speed permanent winding induction coreless generator used in the power generation device as an embodiment according to the present invention, one set is formed with 15 electrodes. Two sets in total are produced and they are divided into upper and lower portions, resulting in that an output is produced by a total of 30 poles (coils).

To connect the poles (coils) of the low-speed permanent winding induction coreless generator used in the power generation device as an embodiment according to the present invention with the wires, according to the wiring method of the three-phase specifications of U.V.W, five poles (coils) are connected with the wires as one electrode, in a manner where the wire of the inside of the first pole (coil) and the wire of the outside of the second pole (coil) are connected, then the wire of the inside of the second pole (coil) and the wire of the outside of the third pole (coil) are connected, and so on. Thus, the 15 poles (coils) are divided into three portions serving as individual poles of U.V.W, resulting in the formation of the three-phase electrode. However, six wires in total, consisting of the wire of the inside of the fifth pole (coil) of each of the electrodes divided into the three portions and the wire of the inside of the fifth pole (coil) in the electrode of the other set are connected together. Naturally, the number of poles (coils) is to be changed so as to correspond to the generators of different outputs.

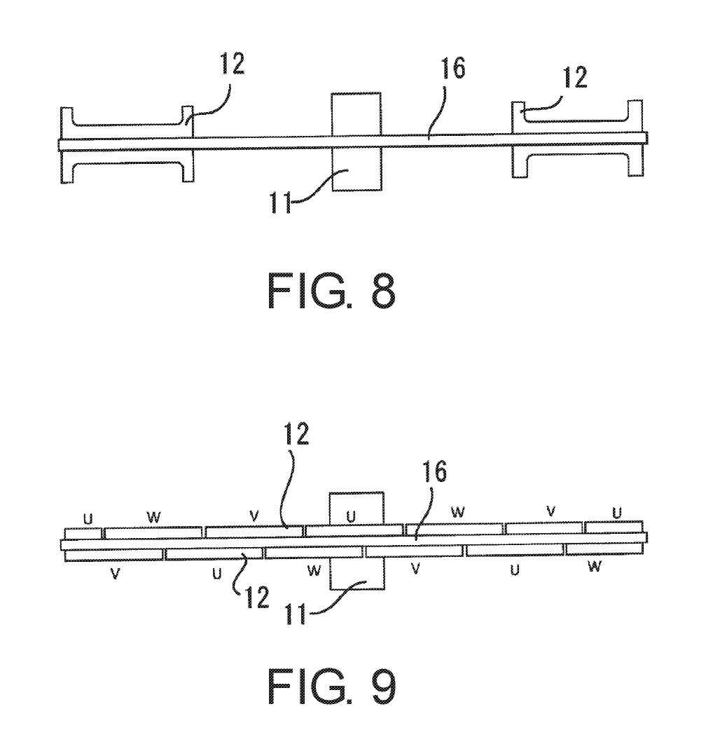

FIG. 8 is a cross-sectional view taken along position A-A′ of the pole (coil) of FIG. 7, and shows the characteristic of the pole (coil) of the low-speed permanent winding induction coreless generator used in the power generation device as an embodiment according to the present invention where the pole (coil) is formed in a concave shape so as to envelope the magnet 4 which rotates, so as to form a path for the rotating magnet.

To give supplementary description for further reference, since only a part of the surface area of the magnet opposes the surface of the coil in the case of the conventional coreless generator, the electromagnetic force contributing to power generation is limited to only F in FIG. 5 and the number of combinations of the magnets and the poles (coils) is ordinary such that 2 poles (coils) are arranged for the magnet 4, the expected output only corresponds to the number thereof. However, the number of electrodes (coils) in the low-speed permanent winding induction coreless generator used in the power generation device as an embodiment according to the present invention is reduced as compared with the usual coreless generator.

The purpose of reducing the number of poles (coils) as compared with the normal balance of the number thereof is to increase the number of turns of the coil in order to utilize as much as possible the magnet whose opposing area is small so as to establish an effective magnetic field and acquire the maximum output of one pole (coil). Corresponding with the reduce in the number of poles (coils), the number of turns of one pole (coil) is increased to enlarge the size of the coil, resulting in that the generator where a high output at low-speed rotation can be obtained is realized.

FIG. 9 is a side view on the side of the stator. On the premise that one set of poles (coils) is formed with 15 poles (coils) which form the electrodes of the low-speed permanent winding induction coreless generator used in the power generation device as an embodiment according to the present invention, FIG. 9 shows a state where the upper and lower two sets are combined. In other words, the upper and lower two sets of electrodes are combined in a state where 2 coils are individually displaced by one half of the dimension such that the two pieces are overlaid against one pole (coil). It is needless to say that, between the upper and lower two sets of electrodes, there is a stator plate 6 incorporating a magnetic steel plate, and each set of electrodes is stuck to the stator plate 6 and is formed and fixed by caulking so as not to make contact with the rotating magnet 4 resulting from the collapse of the winding.

As described above, in the present invention, power obtained from renewable natural energy which uses an energy source such as wind power, sunlight, hydroelectric power, tidal power, wave power, geothermal energy or bioenergy and whose fuel cost is zero is used as a main power source. The power whose fuel cost is zero is used to rotate a variable-speed deceleration motor, and the rotational motion thereof is utilized to rotate the low-speed permanent winding induction coreless generator. Hence, the weakness of various types of renewable natural energy generators which are assumed to generate only a very small amount of unstable power is compensated for and thus it is possible to generate high-output, high-efficient and stable consumed power.

Therefore, by utilizing a very small amount of unstable power which is generated from the renewable natural energy related to the nature and whose fuel cost is zero as the power source of a power generation device which generates high-output and high-efficient power and interconnecting it to the system, it becomes possible to acquire high profit. In addition, what is provided is a compact, smokeless and noiseless local-production-for-local-consumption type system which is in close contact with life, or an environmentally friendly, extremely novel and revolutionary power generation device.

Also, when the supply of the power whose fuel cost is zero which is generated from the renewable natural energy becomes low, by using the power switching unit 5, the supply of power from general power can be received. It is needless to say that when the supply of the power whose fuel cost is zero starts, the supply of general power is, of course, automatically stopped.

The main system of the variable-speed magnetic power generation device as an embodiment according to the present invention generates power as follows: first, the alternating-current power generated by various types of renewable natural energy is converted by the Off Grid Controller device 2 into direct-current power; next, the power output from the Off Grid Controller device 2 is stored in the battery 3; then, the power from the storage battery is connected to the Off Grid Inverter 4 and is converted into alternating-current power; finally, the alternating-current power is connected to the variable-speed deceleration motor M which serves as the power source of the variable-speed magnetic power generation device as an embodiment according to the present invention, and is guided to the rotational motion of a plurality of low-speed permanent winding induction coreless generators G1 to G3.

The reason why the rotational speed of the variable-speed deceleration motor M serving as the main power of the variable-speed magnetic power generation device as an embodiment according to the present invention is so low as to be about 180 rpm is that the rotational speed of the low-speed permanent winding induction coreless generators G1 to G3 coordinated with the rotational motion of M is so low as to be about 200 rpm, and that an outer rotor generator whose outer side rotates is used. This became one of the clues for devising the development of the variable-speed magnetic power generation device as an embodiment according to the present invention.

The low-speed permanent winding induction coreless generator used in the variable-speed magnetic power generation device as an embodiment according to the present invention is developed so that the cogging torque is reduced, and the amount of power generated at low-speed rotation and a high output and high efficiency are acquired, since it needs to be rotated with as little load as possible using a very small amount of power coming from renewable natural energy.

In order to acquire a high output at low-speed rotation, there is a core-type generator using an electromagnetic steel plate (core). However, a significant cogging torque is produced, and thus it is impossible to acquire a high output with a small amount of consumed power. Therefore, the low-speed permanent winding induction coreless generator which follows the principle of “Simple is Best” is developed so that a high output is obtained at low-speed rotation (60 to 200 rpm) with a small amount of initial energy.

Table 1 below shows reference numerical values where a commercial coreless generator (upper stage) and the low-speed permanent winding induction coreless generator as an embodiment according to the present invention (lower stage) are compared.

TABLE 1

| | Generator | Number | Number | Current | Voltage | Output |
|---|---|---|---|---|---|---|
| Items | (kW) | of poles | of cores | (A) | (V) | (W) |
| Commercial | 10 | 64 | 48 | 19 | 529.6 | 1009.7 |
| Developed | 10 | 40 | 30 | 25.8 | 402 | 1037.1 |

| | | Outer | Weight |
|---|---|---|---|
| Items | Number of revolutions (rpm) | diameter (mm) | (kg) |
| Commercial | 300 | 600 × 188 | 96 |
| Developed | 200 | 652 × 186 | 105 |

It is obvious that, as shown in the table above, even when the 10 kw generators of the same output and the same mode are compared, they differ from each other in the number of poles (magnets) and the number of cores (coils).

In addition, since the newly developed low-speed permanent winding induction coreless generator disperses a magnetic attractive force to cancel the cogging torque, it is possible to perform a smooth rotational motion with a small amount of energy, resulting in a novel generator which can realize high-output power generation at low-speed rotation.

The features of the low-speed permanent winding induction coreless generator adopted in the variable-speed magnetic power generation device of the present invention are as follows:

1) It is an outer rotor generator where a rotor placing small burden on the rotational motion is on the outer side;

2) It is a generator which can obtain a high output at low-speed rotation in a range of 60 to 200 rpm;

3) It is a generator which is formed so as to envelope an electrode (core) according to the shape of the magnet, which thereby increases a magnetized position to utilize the gaps between the poles of the cores as effectively as possible, thereby enhancing the efficiency of power generation and reducing the cogging torque to generate high-output power-generating capacity even with a small amount of kinetic energy;

4) It is a generator which is small in size, noiseless, pollution-free and low-priced, and whose fuel cost is zero;

5) In addition, the variable-speed magnetic power generation device of the present invention is developed so that the total power obtained from installing the variable-speed magnetic power generation device via a bypass in equilibrium in a solar power plant which has already been interconnected to the system and operating it is coupled to the system as stable high-output generated power, and setting forth the effectiveness of the renewable natural energy which has been expected to produce only a very small amount of unstable power.

The low-speed permanent winding induction coreless generator adopted in the variable-speed magnetic power generation device of the present invention is a system of a power generation device where, since the low-speed permanent winding induction coreless generator is an outer rotor type, 2 to 5 low-speed permanent winding induction coreless generators can be individually independent, are aligned in one row, and a conductive component fitted to one shaft, coordinated with the variable-speed magnetic power generation device in the same position as the generators, is rotated, and thus high-output power can be generated in each of the generators.

The variable-speed magnetic power generation device of the present invention obtains power from various types of renewable natural energy (such as wind power, sunlight, hydroelectric power, tidal power, wave power, ocean current energy, geothermal energy and bioenergy) which is used to rotate the generator, and with the rotational motion transmitted from the shafts rotated by being coordinated and integrated, the low-speed permanent winding induction coreless generator is rotated to generate consumed power. The essential number of revolutions (output) of the low-speed permanent winding induction coreless generator is not at its maximum; the average stable speed is 60 to 70% of the maximum rotational speed (140 to 180 rpm). Thus, the variable-speed magnetic power generation device according to the present invention is developed targeting a long-term stable life of the generator and sufficient power generation.

The low-speed permanent winding induction coreless generator which is the main part of the variable-speed magnetic power generation device of the present invention is designed to have performance for producing an output of up to 60 kw.

### INDUSTRIAL APPLICABILITY

Since, as described above, the adopted configuration is one where the power that is generated from renewable energy is temporarily stored in a storage battery, the output from the storage battery is used to drive the motor and rotate a plurality of generators to generate power, and a part thereof is stored in the storage battery and the remaining power is output, as consumed power, to the interconnection of the system, renewable natural energy can be effectively utilized, and thus it is unnecessary to depend on nuclear power or the like, where prediction of damage, which needs to be done when a danger or an unexpected situation occurs, is impossible.

### REFERENCE NUMERALS

1 Generator using renewable natural energy
2 Storage battery control system (Off Grid Controller)
3 Storage battery
4 Storage battery conversion system (Off Grid Inverter)
G1, G2, G3 Generator
5 Automatic switching unit
6 Storage battery control system (Off Grid Controller)
M Motor
7 Communication device
8 Commercial electric power for emergency
9 Converter
B Belt
P Driven pulley
p Driving pulley
11 Shaft
12 Coil
13 Rotor
14 Magnet
15 Bearing
16 Magnetic steel plate

What is claimed is:

1. A power generation device using renewable energy comprising:
a storage battery configured to temporarily store electric power generated through renewable energy; and
a plurality of electric power generators along with a motor, the plurality of electric power generators configured to be caused, by the motor driven through electric power output from the storage battery, to rotate so as to further generate electric power, of which one portion is charged into the storage buttery and the other portion is output to an interconnection system as consumed electric power.

2. The power generation device using renewable energy according to claim 1, wherein
a circuit of said power generating device is configured such that combined use of commercial electric power and electric power output from the storage battery to drive the motor is allowed.

3. The power generation device using renewable energy according to claim 1, wherein
water pressure of water supply, agricultural water, or pumped-storage hydroelectricity is used in addition to wind power or sunlight, as the renewable energy.

4. The power generation device using renewable energy according to claim 2, wherein
water pressure of water supply, agricultural water, or pumped-storage hydroelectricity is used in addition to wind power or sunlight, as the renewable energy.

5. The power generation device using renewable energy according to claim 1, wherein
coils of each of the plurality of electric power generators are spaced in a state where the coils are wound circularly and formed in concave shapes so as to face both side surfaces of a permanent magnet, respectively.

6. The power generation device using renewable energy according to claim 2, wherein
coils of each of the plurality of electric power generators are spaced in a state where the coils are wound circularly and formed in concave shapes so as to face both side surfaces of a permanent magnet, respectively.

7. The power generation device using renewable energy according to claim 3, wherein
coils of each of the plurality of electric power generators are spaced in a state where the coils are wound circularly and formed in concave shapes so as to face both side surfaces of a permanent magnet, respectively.

8. The power generation device using renewable energy according to claim 4, wherein
coils of each of the plurality of electric power generators are spaced in a state where the coils are wound circularly and formed in concave shapes so as to face both side surfaces of a permanent magnet, respectively.

9. The power generation device using renewable energy according to claim 1, wherein
a rotational force of a shaft of the motor drives:
a driven pulley of an electric power generator for charging out of the plurality of electric power generators; and
a driven pulley of an electric power generator for consumed electric power out of the plurality of electric power generators,
so as to cause outer rotors of the plurality of electric power generators to rotate thereby generating electric power.

10. The power generation device using renewable energy according to claim 2, wherein
a rotational force of a shaft of the motor drives:
a driven pulley of an electric power generator for charging out of the plurality of electric power generators; and
a driven pulley of an electric power generator for consumed electric power out of the plurality of electric power generators,
so as to cause outer rotors of the plurality of electric power generators to rotate thereby generating electric power.

11. The power generation device using renewable energy according to claim 3, wherein
a rotational force of a shaft of the motor drives:
a driven pulley of an electric power generator for charging out of the plurality of electric power generators; and
a driven pulley of an electric power generator for consumed electric power out of the plurality of electric power generators,
so as to cause outer rotors of the plurality of electric power generators to rotate thereby generating electric power.

12. The power generation device using renewable energy according to claim 4, wherein
a rotational force of a shaft of the motor drives:
a driven pulley of an electric power generator for charging out of the plurality of electric power generators; and
a driven pulley of an electric power generator for consumed electric power out of the plurality of electric power generators,
so as to cause outer rotors of the plurality of electric power generators to rotate thereby generating electric power.

13. The power generation device using renewable energy according to claim 5, wherein
a rotational force of a shaft of the motor drives:
a driven pulley of an electric power generator for charging out of the plurality of electric power generators; and
a driven pulley of an electric power generator for consumed electric power out of the plurality of electric power generators,
so as to cause outer rotors of the plurality of electric power generators to rotate thereby generating electric power.

14. The power generation device using renewable energy according to claim 6, wherein
a rotational force of a shaft of the motor drives:
a driven pulley of an electric power generator for charging out of the plurality of electric power generators; and
a driven pulley of an electric power generator for consumed electric power out of the plurality of electric power generators,
so as to cause outer rotors of the plurality of electric power generators to rotate thereby generating electric power.

15. The power generation device using renewable energy according to claim 7, wherein
a rotational force of a shaft of the motor drives:
a driven pulley of an electric power generator for charging out of the plurality of electric power generators; and
a driven pulley of an electric power generator for consumed electric power out of the plurality of electric power generators,
so as to cause outer rotors of the plurality of electric power generators to rotate thereby generating electric power.

16. The power generation device using renewable energy according to claim 8, wherein
a rotational force of a shaft of the motor drives:
a driven pulley of an electric power generator for charging out of the plurality of electric power generators; and
a driven pulley of an electric power generator for consumed electric power out of the plurality of electric power generators,
so as to cause outer rotors of the plurality of electric power generators to rotate thereby generating electric power.

17. A method of generating power comprising the steps of:
generating electric power through the use of wind power, solar energy, or a water pressure;
temporarily storing the electric power in a storage battery;
driving a motor through the electric power output from the temporary buttery so as to cause a plurality of electric power generators to rotate thereby further generating electric power;
charging one portion of the electric power further generated by the plurality of electric power generators into the storage buttery; and
outputting the other portion of the electric power further generated by the plurality of electric power generators, as consumed electric power, to an interconnection system.
